(19) United States
(12) Patent Application Publication
(10) Pub. No.: US 2015/0234840 A1
(43) Pub. Date: Aug. 20, 2015

(54) Browser-Based Designer Tool For A User Interface And The Administration Of Tiles

(71) Applicant: LiveTiles LLC, New York, NY (US)

(72) Inventors: Karl Redenbach, New York,, NY (US); Sepideh Ghajar, New York, NY (US); Damien K. Robinson, New York, NY (US)

(21) Appl. No.: 14/706,437

(22) Filed: May 7, 2015

Related U.S. Application Data
(63) Continuation-in-part of application No. 14/322,144, filed on Jul. 2, 2014.
(60) Provisional application No. 61/842,719, filed on Jul. 3, 2013.

(51) Int. Cl. G06F 17/30; G06F 3/0482; G06F 3/0486; G06F 3/0484

(52) U.S. Cl. CPC G06F 17/3089; G06F 3/04842; G06F 3/0482; G06F 3/0486

(57) ABSTRACT

Systems and methods for users to create and modify a custom responsive design web page and a web based application which utilizes drop and drag interaction to create a custom responsive intranet, internet or extranet web page. The creation and modification of the layout and content of the responsive intranet, internet or extranet web page content can be easily changed without the user needing to know computing coding or web-development languages such as a prototype-based scripting language or markup languages. The systems and methods can be used allow a user to change the look and content according to the size of the screen of the viewing device.

This application is a continuation-in-part of U.S. patent application Ser. No. 14/322,144 filed on Jul. 2, 2014 that claims priority of U.S. Provisional Application No. 61/842,719 filed on Jul. 3, 2013.

### BACKGROUND

Currently there are no web-based tools that enable a non-technical user to create and modify a custom responsive design web page. Furthermore, there is currently no web based application which utilizes drop and drag interaction to create a custom responsive intranet, internet or extranet web page.

Prior to the current invention, the creation of a responsive intranet, internet or extranet web page would by typically conducted by a developer and/or a web designer using web development tools. These tools require specific technical knowledge and training and are both time consuming and complicated to use.

Other systems can provide page templates that are responsive, however, any modifications to that web page requires the same technical skills and knowledge.

This application builds upon and improves upon the system and method set forth in U.S. patent application Ser. No. 14/322,144 filed on Jul. 2, 2014 which disclosed a system a method used to deploy intranet, extranet and internet web pages, using a tile based deployment system. However, the system and method disclosed in that application does not allow for responsive design using a tile based system. Further, at this time, there are no system and method as the systems and methods disclosed herein, including a system and method which allows for rapid responsive web deployment using a tile based, drag and drop system by a non-technical user.

### SUMMARY

The inventors have developed a system and methods for users to create and modify a tile based intranet, internet or extranet web page, including a website containing functional tiles to be responsive. It should be noted that throughout this specification the word “including” means “including but not limited to”.

The content, page responsiveness, and placement of the tiles can be easily changed without the user needing to know any computer coding or web-development languages such as a scripting or HTML mark-up languages.

The systems and methods presented herein can be used to create a responsive tile based intranet, internet or extranet websites of any type of Web application platform associated with intranet content management and document management.

The system and methods are especially useful as an interface design tool for Microsoft SharePoint® products. The system and methods described within can be employed with both on-premise and cloud based versions.

The system and methods outlined here can also be applied to non-SharePoint® web page solutions. A person of ordinary skill in the art will understand that the systems and method disclosed herein can be used for many types of web page solutions.

The system and methods allow the user to create a multitude of different tile arrangements and configurations and position them so that they are responsive based on the device the page is currently being viewed through. Additionally, the system and methods can provide out of the box templates, greatly reducing the time and effort needed to build multiple responsive pages. The ability to create customizable tile configurations or to use pre-set templates allows for the best user experience available while still providing page design flexibility beyond that of a typical responsive template.

This summary is provided to introduce simplified concepts for using a browser based tool for the user interface and administration of tiles for a responsive web page that are further described below in the Detailed Description and/or shown in the Figures. This summary is not intended to identify essential features of the claimed subject matter, nor is it intended for use in determining the scope of the claimed subject matter. The term “techniques” as used herein can include devices, systems, apparatuses, components, operations, and/or methods as permitted by the context in which the term is used.

### BRIEF DESCRIPTION OF DRAWINGS

Examples of building a responsive web page using this system and methods are described with reference to the following drawings. The same numbers are used throughout the drawings to reference like features and components:

FIG. 1 illustrates accessing the responsive layout options in the application.

FIG. 2 illustrates adding a layout container to the responsive page canvas.

FIG. 3 illustrates adding a layout row to the responsive page canvas.

FIG. 4 illustrates adding another layout row to the responsive page canvas within an existing row.

FIG. 5 illustrates selecting the Tile menu.

FIG. 6 illustrates adding a tile from the tile menu to the responsive page layout using drag and drop

FIG. 7 illustrates adding a second tile from the tile menu to the responsive page layout using drag and drop.

FIG. 8 illustrates opening up a tile's configuration options.

FIG. 9 illustrates selecting layout options for a specific tile.

FIG. 10 illustrates using the tile configuration options to hide a tile for large device page viewing.

FIG. 11 illustrates the multiple options for controlling visibility across device media queries.

FIG. 12 illustrates using the layout menu to control how a row will look on a medium device.

FIG. 13 illustrates using the layout menu to control how a row will look on a small device.

FIG. 14 illustrates using the layout menu to control how a row will look on an extra small device.

### DETAILED DESCRIPTION

### Overview

This document describes techniques for a web browser based tool for a non-technical user to create a responsive intranet, extranet or internet web page. In a preferred embodiment a system and method a responsive intranet, extranet or internet web page is created using a mix of both columns and rows and utilizing a drag and drop approach. The systems and methods encompass other systems and methods for a user to create or modify a responsive intranet, extranet or internet web page. Such other methods include but are not limited to using a component, icon, tab or way to allow the user to change the design in the design view.

Furthermore, systems and methods are provided to enable users to modify or replace existing page components and functions using a web browser. The result is a page that is able to adjust its layout between large screen devices such as desktop computers down to small screened devices such as mobile phones. The complexity of coding such a page is hidden from the user and exposed via the system.

The following is an illustrative example of a preferred embodiment of the invention disclosing how using a browser based tool for user interface and administration of responsive web pages can be used across multiple systems and methods.

As used herein, the terms “component,” “system” and the like are intended to refer to a computer related entity. This includes but is not limited to hardware, a combination of hardware and software, software or software in execution. For example, a component may be, but is not limited to, a process running on a processor, a processor, an object, an executable, a thread of execution, a program, and/or a computer. By way of illustration, both and application running on a computer and the computer itself can be a component. One or more components may reside within a process and/or thread of execution and a component may be localized on one computer and/or be distributed between two or more computers.

In addition, the term “end-user” is used to differentiate between the user who is using the application and the user who is viewing the completed website from outside the method being used on this website. For example, an end-user may be but is not limited to, a person using the application without having access to designing the website, a user who has completed designing the website and wishes to see how the website looks and/or a person who is being shown the website.

### Preferred Embodiment

A preferred embodiment of the system and method of the disclosed invention for implementing a responsive design canvas is disclosed below. Other embodiments of the disclosed invention are discernible by a person of ordinary skill in the art from the disclosure herein. The system and method can be used within SharePoint®. However, it is understood that the system and technique can be used with any type of Web application platform. A person of skill in the art would recognize the proceeding description in its relation to the features and functionalities of SharePoint®.

In a preferred embodiment the User Interface consists of a HTML 5 web page presented as a visual design canvas. The Web Effects Controller Layer Component is comprised of connector classes to fetch JavaScript (JS) Functions, insert HTML element code, and control the required classes for Cascading Style Sheets (CSS). These components are implemented in the page in response to a user's action. In the illustrative examples below the user action consists of dragging and dropping a layout component onto the page using for example a mouse or any input device known to those of skill in the art. However, the disclosed systems and methods contemplate other types of user actions, including the use of drop down menus, selecting icons, using soft keys or using other techniques known to those of skill in the art. The logic controlling the behavior of the page and the tiles within it are controlled by the user's interaction with the configuration options presented to them via the user interface.

### Example Methods

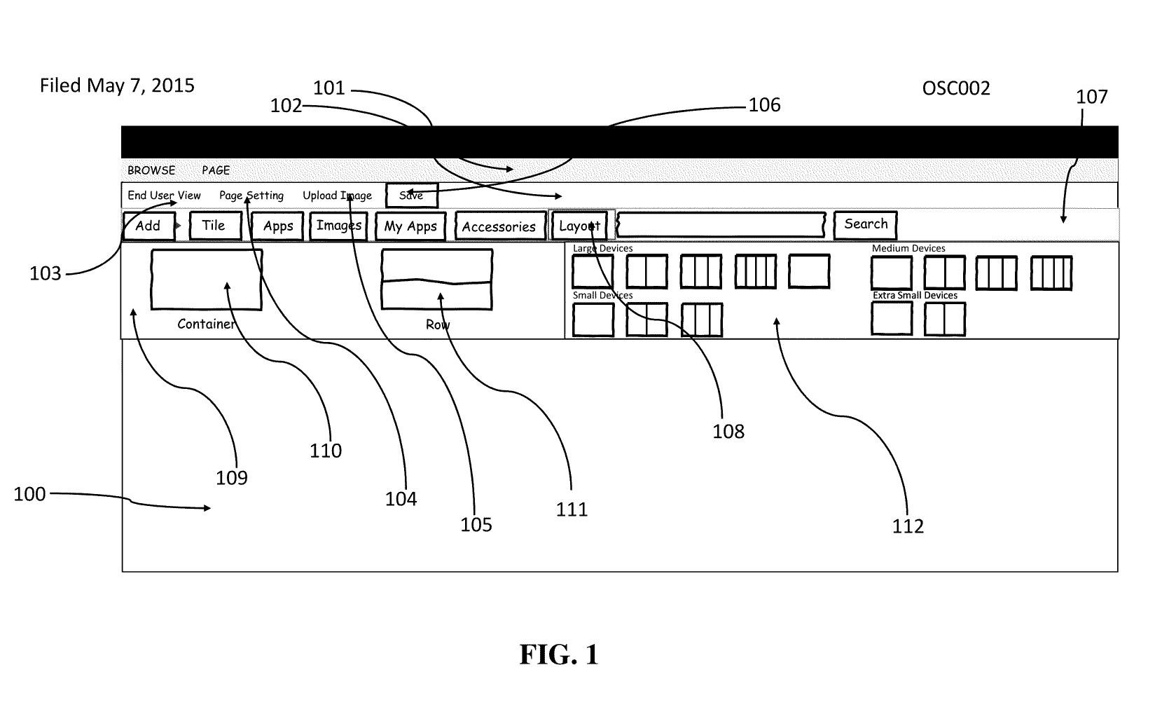

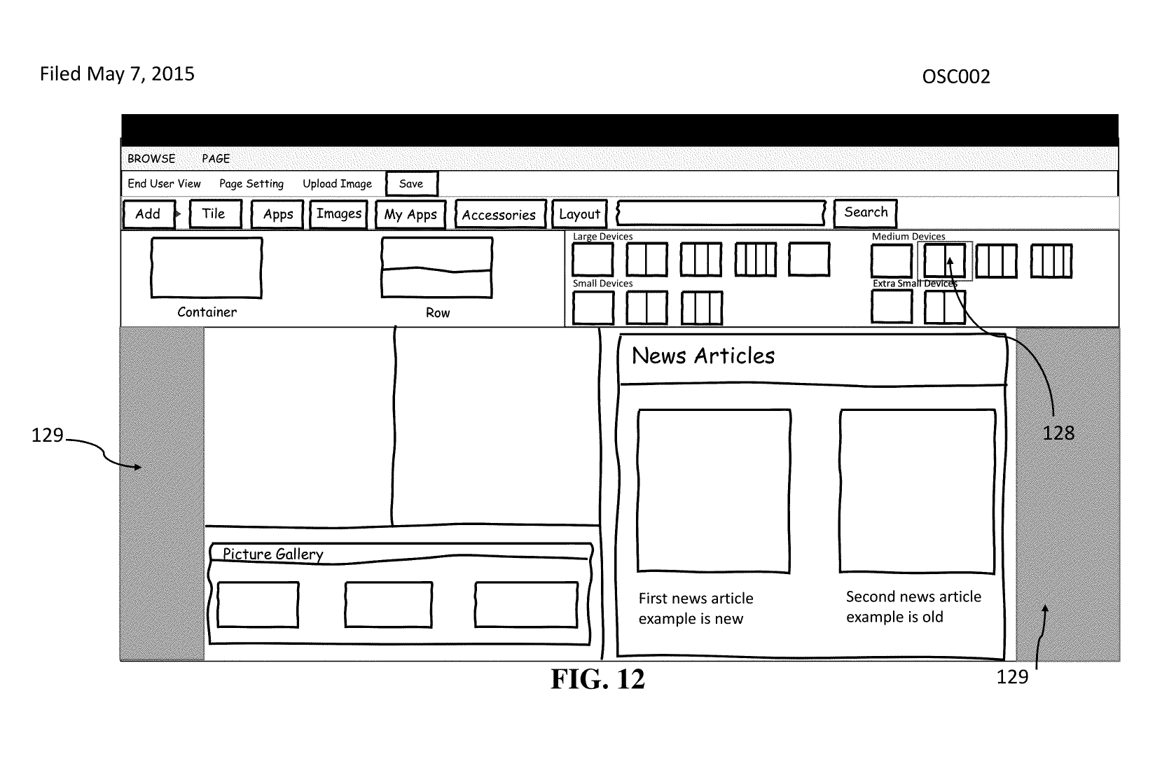

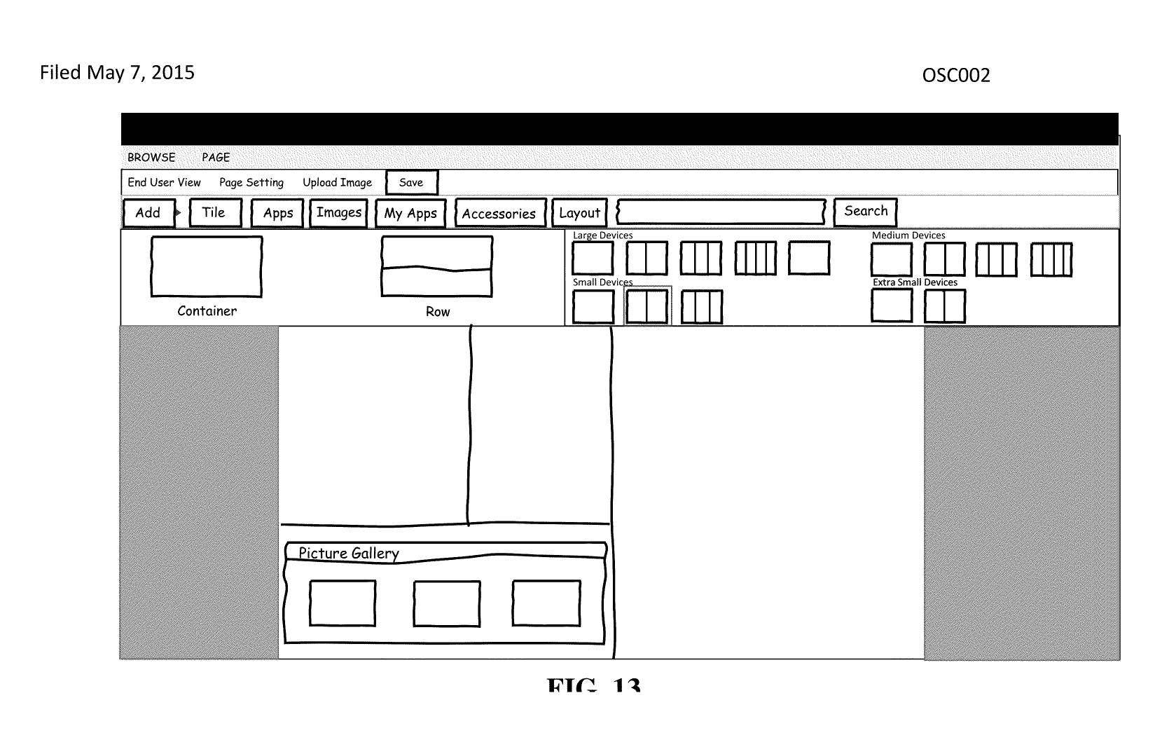

FIG. 1 shows an illustrative example of a user in design view for creating and editing pages within the proposed system. This design view or administrative page can be implemented within SharePoint® and also outside of SharePoint® in any web based browser application or product. The proposed methods and systems will have different views and/or modes depending on the proposed screen size in which the page is currently being edited. FIGS. 12-14 which will be discussed in more detail later herein show an illustrative example of a design view showing how the proposed responsive web page will appear on different size devices.

The system and method also may contain one or more views or modes depending on the situation or function required. For example, the system or method may contain a design view or administrative view that will allow a user to create and modify a responsive intranet, extranet or internet web page. Access to the administrative view may be limited to certain users to prevent unrequested modifications of a responsive intranet, extranet or internet web page.

All features, functions, or techniques can be set forth in one view or mode or selected from drop down menus or by selecting icons within the workspace or by other techniques known to those of skill in the art. In a preferred embodiment, the system and method contains the option to be able to alternate the view between a large device view, a medium device view and a small device view in order to determine how the page will look to an end user based on the proposed screen size said end user would be viewing the intranet, extranet or internet website from.

When a user wants to modify or create a responsive page or tile within the page, the user accesses the design canvas view that gives the user the privilege or the right to create and modify the responsive page. For example, the user can access the design view by, for example, selecting the design view from a drop down menu or by a toggle icon or other known method. In a preferred embodiment a user can either select a previously created template of an array of containers, rows and tiles or choose to create a blank page. Alternatively, the systems and methods can have one or more default templates that a user could select. These default templates may be the most used templates or the most preferred template for a particular device. Previously created or modified templates can be saved by the user at any stage.

The proposed methods can provide default choices for each option that would be implemented if the user does not select a different choice. When the user is finished with the page configuration options, the method can provide a technique for the user to accept the configuration parameters whereupon these options are then implemented onto the page. These can include, but are not limited to, a save option to be able to save changes to the entire page and/or an auto save option to save changes as they are made in real time.

The illustrative design view of FIG. 1 shows one possible design view of the method and system that would allow a user to create and modify a responsive intranet, extranet or internet web page. The illustrative design view 100 shows a series of icon arranged in bars. In the illustrative example of FIG. 1 there is an icon bar 101 containing a Browse and Page functions that can be selected by a user. In addition, in the illustrative example there is a second icon bar 102 containing common functions that a user may want to select. For example, the user may want to view the responsive intranet, extranet or internet web page 103, to change the page settings 104, to upload the image 105 or to save the design page template 106. In the illustrative example of FIG. 1 there is a third icon bar 107 containing functions and content icons. In the illustrative example of FIG. 1 a user has selected the Layout function 108. In the illustrative example of FIG. 1 this has resulted in the display of a fourth bar 109 below the third icon bar 107 containing icons showing possible layout options. As stated above, the methods and systems of the invention contemplate other known methods and techniques by which a user can create and modify a responsive intranet, extranet or internet web page using for example, drop down menus or softkeys. In the illustrative example of FIG. 1 the icon bar 109 includes a configuration function allowing a user to add one or more containers 110 and a function 111 to add one or more lines. In the illustrative example of FIG. 1 icon bar 109 also includes layout options for the maximum number of columns 112 that are available for large, medium, small and extra small device screen sizes.

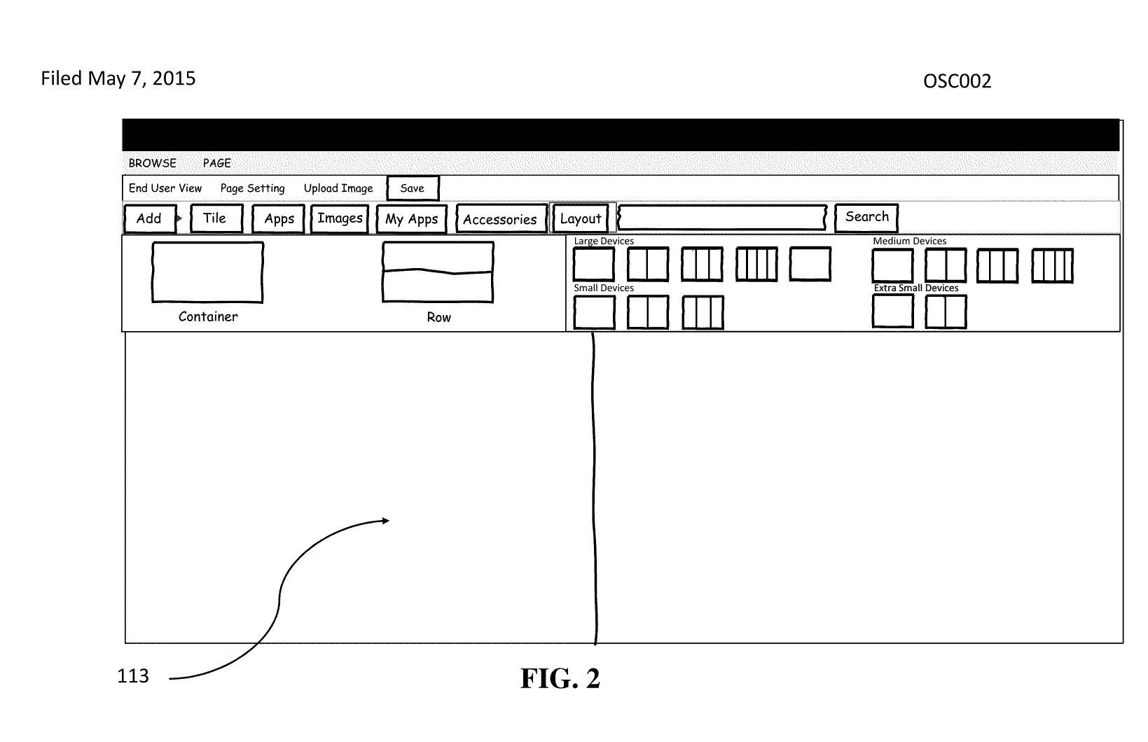

The illustrative example of FIG. 2 shows that a configuration function has been invoked. The user has chosen to add a container to the page 113. In the illustrative example of FIG. 2 this was accomplished by dragging a container 110 from the configuration space onto the design canvas. Other known methods are contemplated including using pull down menus or softkeys.

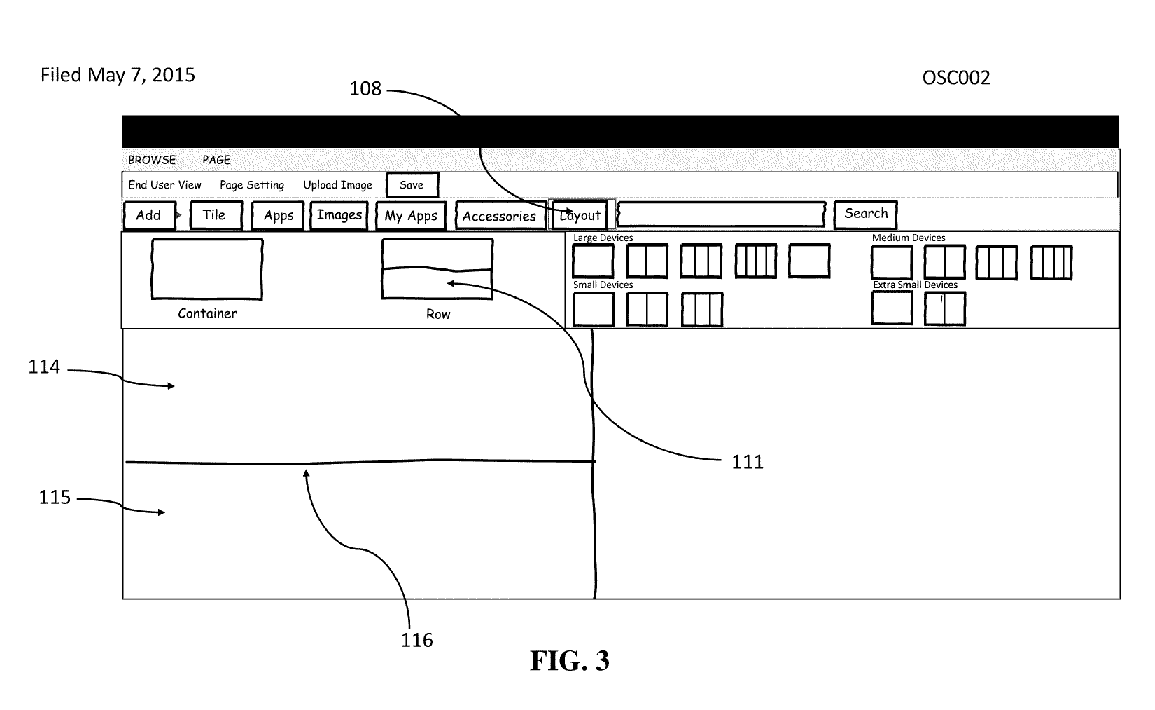

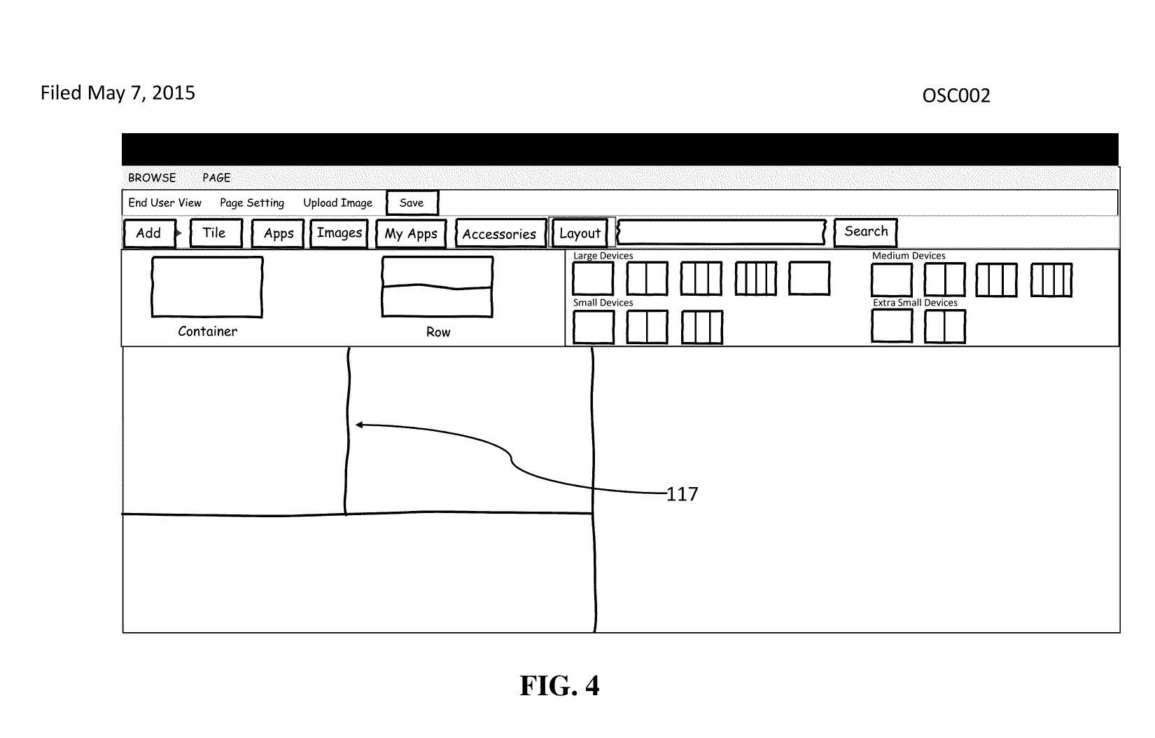

In the illustrative example in FIG. 3 the user has created two rows 114 and 115. In the example of FIG. 3 this was accomplished by accessing the row function 111 and dragging a row 116 into the container on the design canvas. In FIG. 4 the user has expanded on row creation by dragging another row 117 onto the container in the design canvas to configure the layout of page. These are only some of the features which the user can select. Additional features that user could select to create a responsive page include the option to position the rows and containers as well as the ability to resize rows and containers. A person of ordinary skill in the art would understand additional options and features that could be used for the layout of responsive intranet, extranet and internet web pages.

In a preferred embodiment such as in the illustrative examples of FIGS. 2-4, in order for a user to be able to modify the rows and containers in the page, the user will have to drag containers and rows onto the design area in order to add new areas in which the responsive design aspects of the page will be used to structure the page. Other known methods to insert containers, rows or other layout features are understood as within the disclosed system and methods, including using drop down menus or softkeys.

In order to save the configuration that the user has designed, the user will have to save the page. In the illustrative example set forth in FIG. 1 the save function is an icon 106. In other embodiments the save function could be accessed by drop down menus or through softkeys. The save function may provide an option for the user to save the page to either a gallery in which it can be used as a template or saved as a page in which the page can be deployed to either an intranet, extranet or internet web site and/or be saved for further editing, customizations and/or revision.

Preferably, after the user has configured the layout of the template or new page, the user will then proceed to set up content for the page. For example, the user may select the tiles and/or application tabs, or other content of the page based on the containers and rows the user has set up in the design view using for example the Layout feature. However, the order of the steps is not important and the user has the option to perform and of these steps which are listed above and/or below in any order. For example, the user could add some tiles and applications to a page before setting up the option to add in containers to change the looks of how the page works, and then drag the tiles around into created containers in order to change how the page looks.

Once the user has created the layout and content of the responsive intranet, extranet and internet web pages, the user may have the ability to switch to different previews and/or design canvases which show how the created web page will look based on the changes that the user has created for different device views. The user will have the ability to open up previews of how the page will look and will allow the user to edit these changes within the preview thus allowing them to modify and select tiles within the design canvas to edit on different levels.

It should be noted that the user can perform any of the multitude of functions described such as selecting and moving tiles or groups of tiles in the current template by using any type of input device or technique. One type of well-known devices is a computer mouse that contains a plurality of buttons that allows a user to hover and select a tile and then drag it to the desired container and/or location at which the user then opts to drop the tile in this location. Another input device that was considered by the inventors is a touch-sensitive screen that would allow the user to select, move and perform functions by touching the desired portion of the display interface.

The system and method of the invention can provide a plurality of templates containing pre-determined mix of responsive container layouts or configurations, pre-determined content layouts or configurations or a combination of both responsive container and content layouts and configurations. These templates can be selected or changed at any time. For example, a user could have set up a template configuration of similar content in which to deploy multiple pages using this template. The user can select this template from among the pre-created templates that could have been created having the characteristics that the user has provided. If no template had been selected, the user will see the page outlined in FIG. 1.

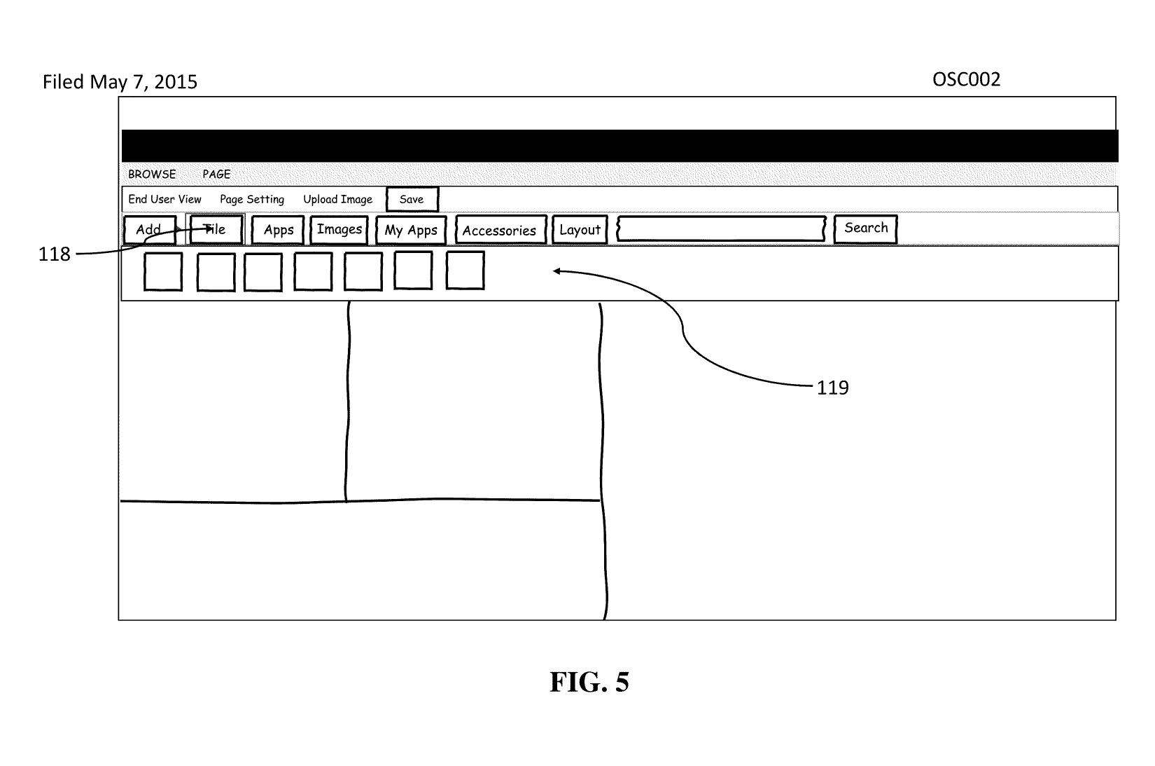

The illustrative example on FIG. 5 shows the change of state of the responsive intranet, extranet and internet web page from the setting up of the responsive layer of the page into the content setup of the page. This shows a change in how the user interacts with the page. In the illustrated example of FIG. 5, using a tile based deployment system, the user is shown a screen which allows them to enter content onto the design canvas. In the illustrative example of FIG. 5 the user has accessed the Tile feature 118 which caused a bar or folder of tiles 119 to appear. The tiles that the user can access may be contained in one or more sources, including the a Tile menu folder, the user's own folder, a My Gallery folder containing tiles set up by an administrator or a folder of grouped tiles. Other sources of tiles are contemplated by the system and method disclosed herein.

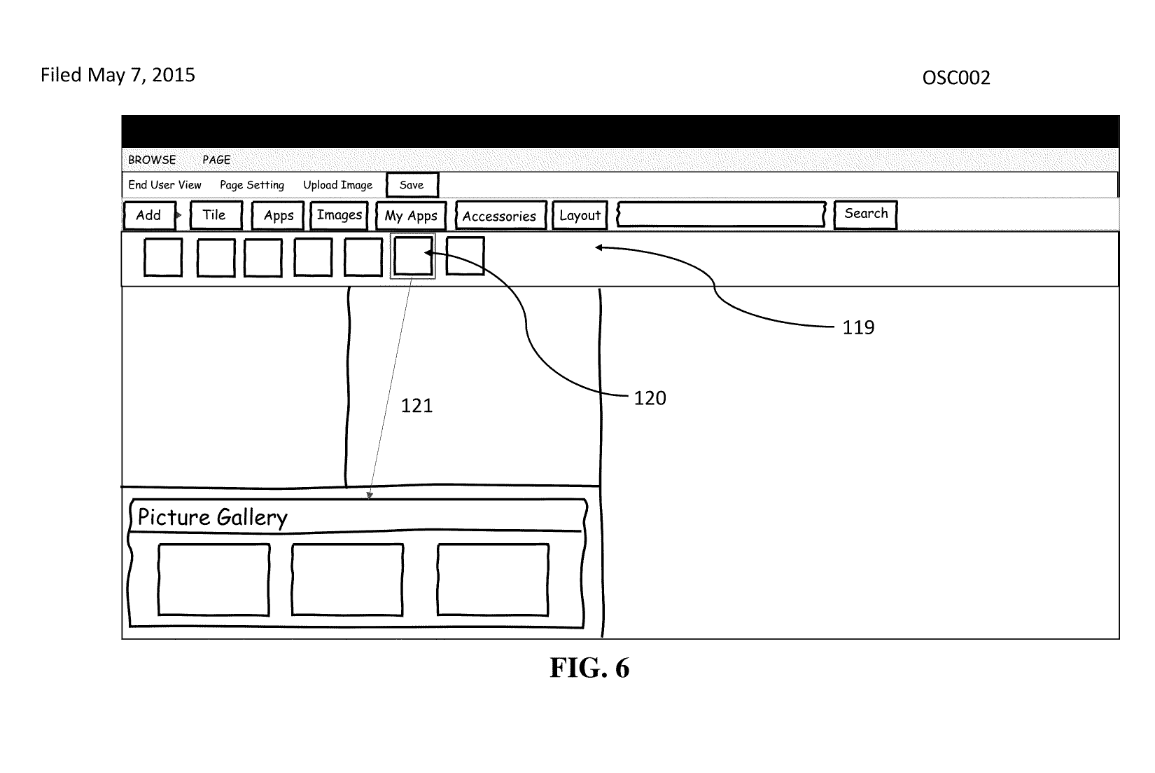

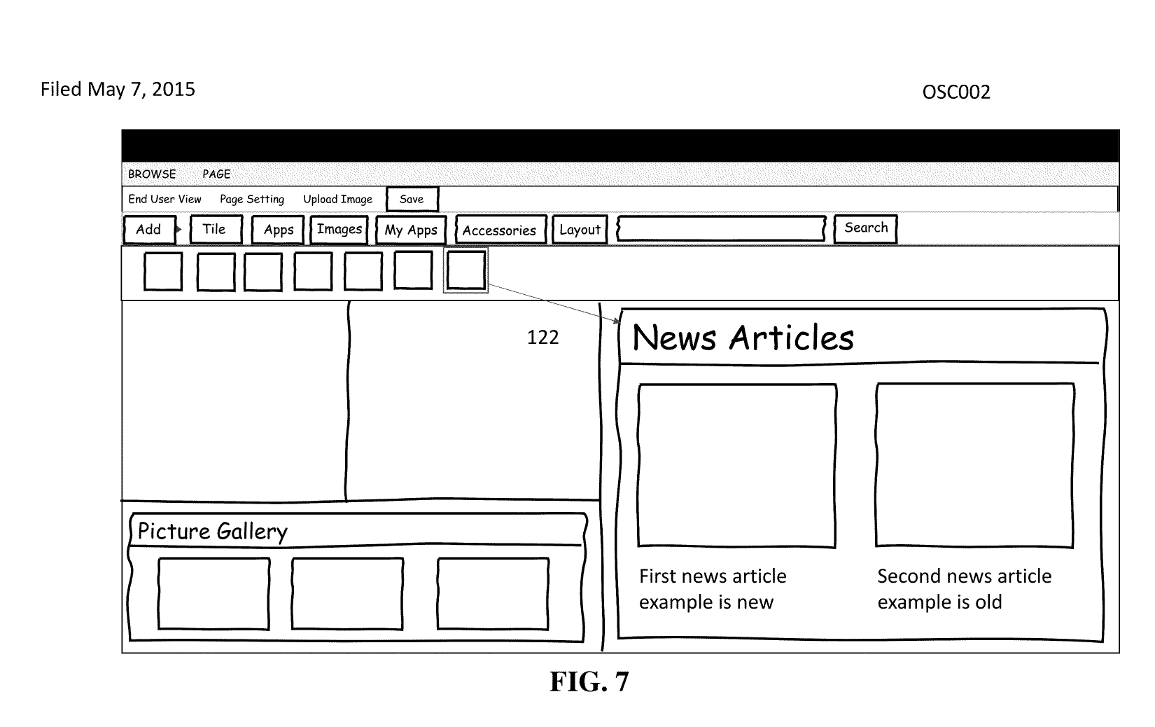

FIGS. 6 and 7 shows examples of tiles that a user can place into the containers or rows on the design canvas. In the illustrative example of FIG. 6 a “Picture Gallery” tile 120 was chosen among the viewable tiles and placed into the lower row in the left container. In the illustrative example of FIG. 6 this was accomplished by dragging and dropping the tile from the tile folder 119 into a row on the design canvas. The user can continue the process of dragging and dropping contents elements into the design canvas. For example, in the illustrative example of FIG. 7, the user has dragged and dropped a News Article tile 122 into the right container on the design canvas. In FIGS. 6 and 7 the contents item was a tile but the system and methods contemplates other contents elements to be placed into the design canvas.

In a preferred embodiment of the system and method the content placed into the design canvas when placed into the design canvas will expand to meet the area of the page in which it is placed into. The user will have the option to resize the content within a container, allowing the user to place more than one bit of content into a container without having to add extra containers into the application than what is necessary.

Embodiments of the system and method also allows the user to have the potential to resize the container which are used to store the content that is being created by the user. Some methods included by not limited to having the ability to enter the height of the tile, being able to drag the size of the tile and/or dragging the size of the tile in order to make the tile match the dimensions that the end user would like.

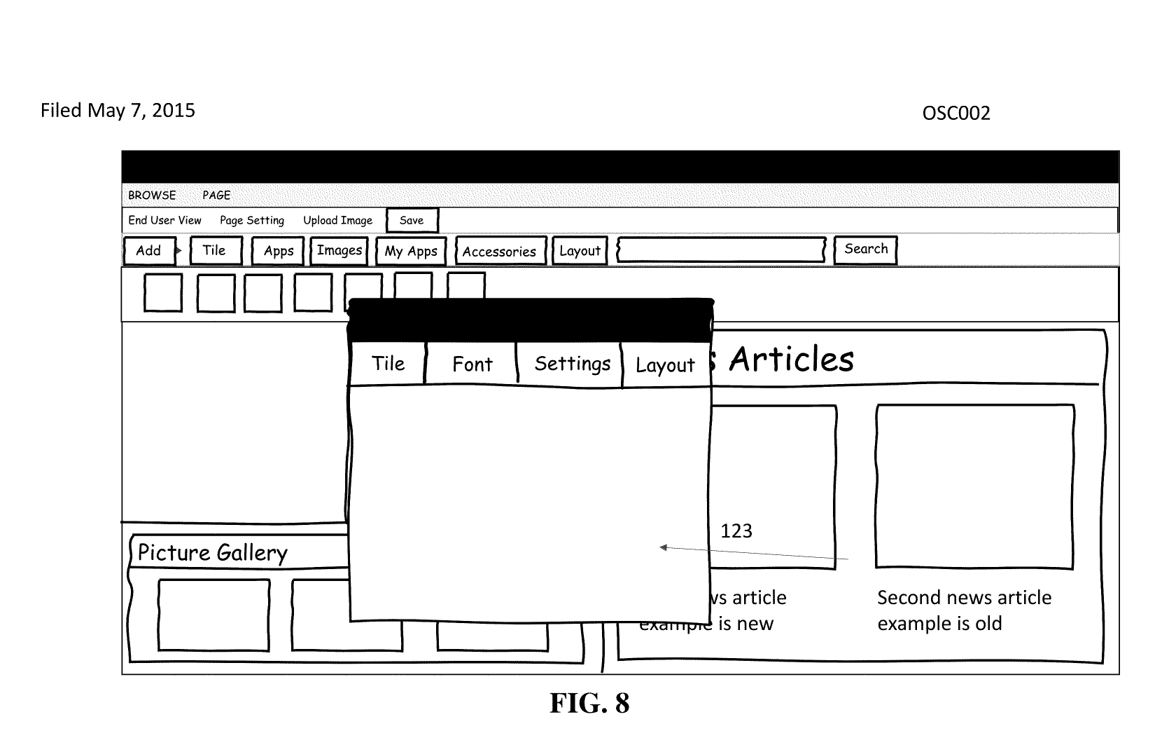

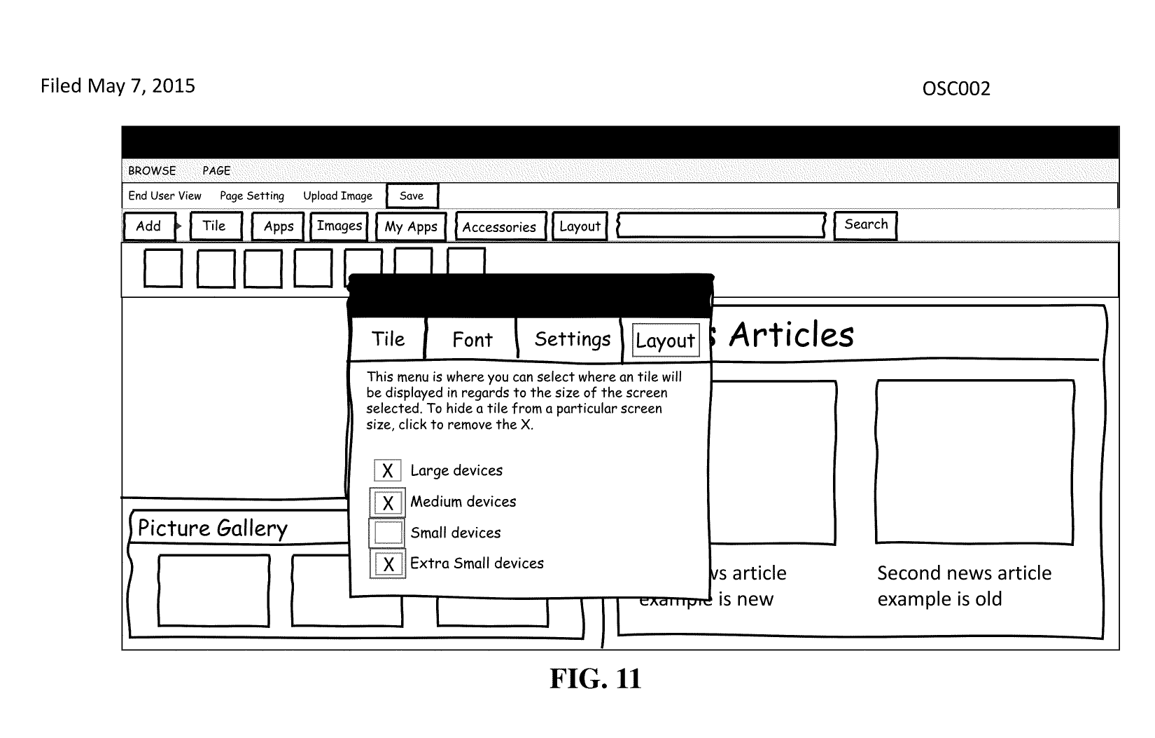

FIGS. 8-11 show illustrative examples of being able to show and hide content based on the size of the screen in which the end user will be viewing the intranet, extranet or internet web page. In the illustrative examples of FIGS. 8-11 a user can access this feature by clicking on a container or the content within the container (i.e. Tile) that causes a configuration menu option to appear.

The user would have the ability to then change at what levels the container or the content would be visible. The examples which are shown in FIGS. 8-10 show the user selecting one of the content based tiles which opens up a menu for the tile. The user then selects the Layout based feature that bring up the features of the tile based on layout.

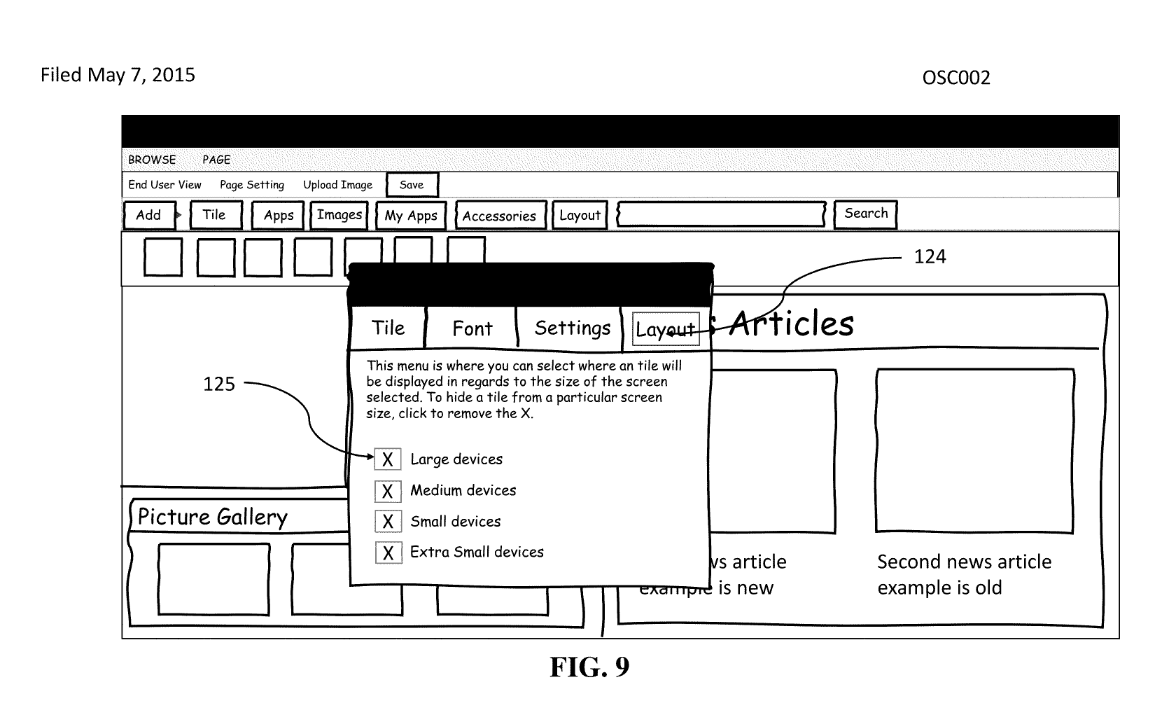

In the illustrative example of FIG. 9 the user has selected the Layout feature by clicking on the Layout icon 124 which caused a screen to appear of the layout options for the container or content. In the illustrative example of FIG. 9 four checkboxes, each with the option to select or deselect each checkbox has appeared. For example, in the illustrative example of FIG. 9 a box labeled “Large devices” has appeared containing a check mark 125 indicating that the container or content will appear when viewed from a device with a large screen. This selection choice can also be adapted to other methods indicate whether a piece of content or a container is visible or hidden, including but not limited to, icons which change color or shade when an option is enabled/disabled and/or a drop down box including text which outlines the options that are available.

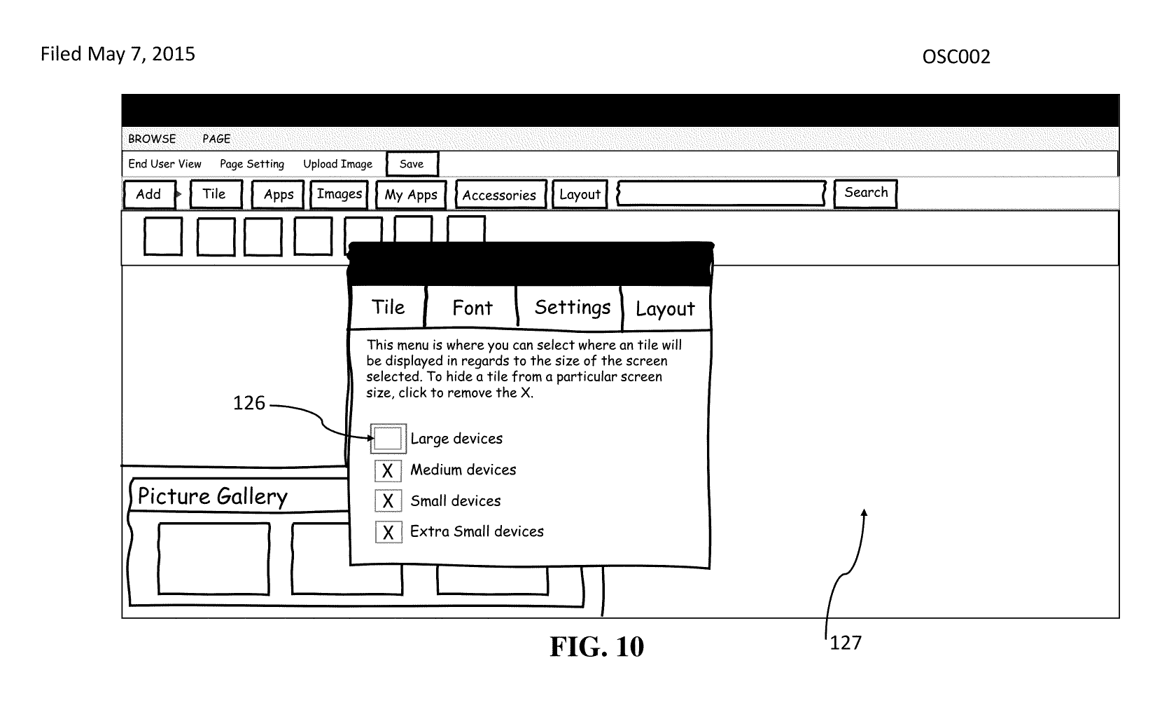

The user has the option to de-select the screen sizes that the user does not want the end-user of the system to see the selected content and/or containers. By de-selecting a certain content and/or container the user is choosing to hide this content and/or container for when viewed on devices having the de-selected screen size. A comparison of FIGS. 9 and 10, shows the effect of de-selecting the large screen device which in the illustrative examples is the screen size selected for the design canvas. For example, in FIG. 9 the large devices button is selected for the News Article content tile and thus this content is visible in the design canvas which is currently in the large device view. By comparison, in FIG. 10 the Large device layout has been de-selected 126 for the New Article content tile and the you can see the effect of these choices because this tile has been removed from the design view when the large view has been de-selected 127.

The system and method allows the user to custom tailor what content is available on particular screen sizes. This has applications which can affect which of these work within the confines of the proposed site. An example of this is setting a news feed which on a website or tablet, works well as it gives a quick reference to either an internal news feed or an external site's news feed. However on smaller applications such as a mobile phone or a watch, this news feed does not work for either the news feed being too cumbersome or unwieldy for the application itself or there being a similar app that is already existing which meets the functionality based on the device which the end user is viewing the web page and/or the user having an application on the page which performs better on a smaller screen. In such situation the user will hide the specified content on such sized devices (such as a “lite” version of some content).

FIGS. 12, 13 and 14 show the design canvas when the user selects to view the canvas in screens other than the pre-selected large screen view. FIG. 12 shows the screen as viewed through a medium device and as in the application, the containers have shrunk in size to accommodate the new design space.

In a preferred embodiment, the system and method cuts off the unutilized sizes of the screen by hiding these areas with a colored border area 129 in which the user is unable to drag any more containers, rows and/or content onto the design canvas in those areas, and the content within the design canvas shifting in order to change how the web page will look within the confines of that device. In the illustrative example of FIG. 12 the available design canvas is outlined, the option to add more potential device breakpoints and to modify the breakpoint sizes can be made available from the page settings menu. By allowing the user to set the breakpoints and the amount of breakpoints for the devices, the system and method allows a user to dynamically set the screen size points in which the website that is being created changes its features and layouts, thus giving the user more choice in determining how the page responds to both devices which are out of the scale or notice of pre-set design sizes and/or change the content based on these devices to better suit the intended audience.

As it stands the technical rules behind the breakpoints would function with large devices being greater than or equal to the largest breakpoint and the smallest devices being less than or equal to a particular breakpoint and other devices falling in between using a maximum and minimum breakpoint to show when the page will change from one state to another state.

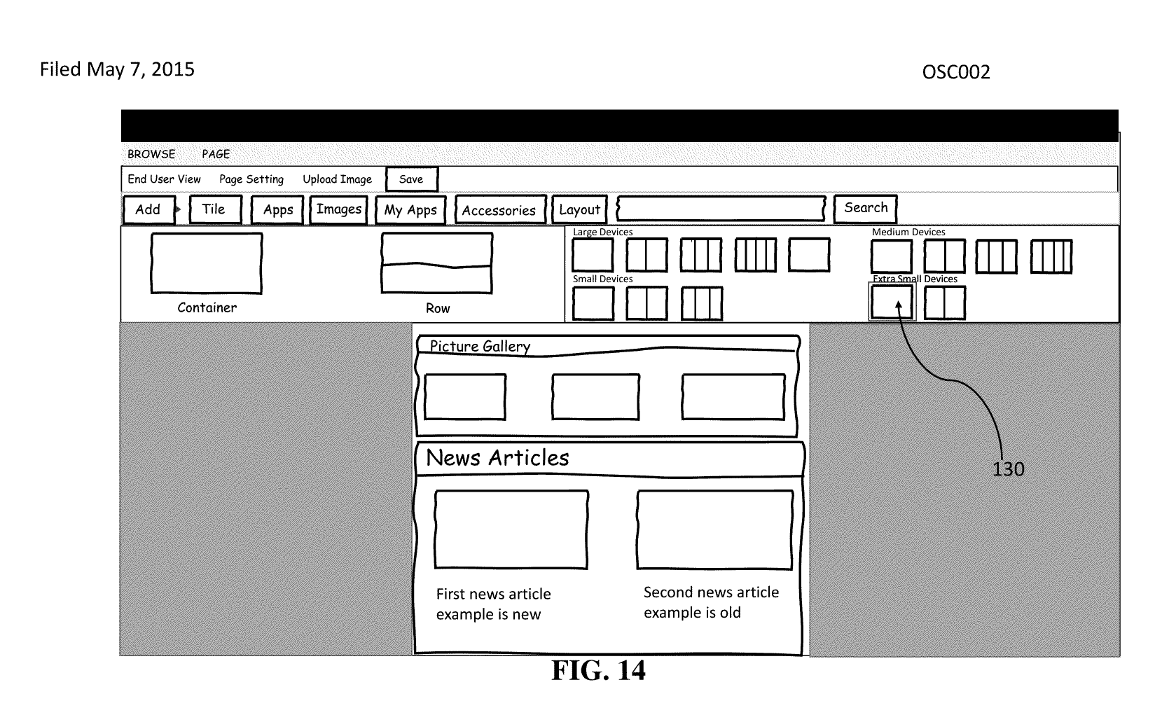

This method also allows for responsive design whilst designing the design canvas itself. As shown in FIG. 14, the application changes how the page looks in order to accommodate the screen in which the page which the end-user is viewing the screen in. In the design view, when swapping to the extra small view, the page re-arranges itself based on the size of the page, with the second row containing the news article is being placed under the first row containing the picture gallery as selected by the end user.

The described system and method allows the user to pre-select the maximum amount of columns that are available to a particular view in order to allow the page to become more responsive without forcing the user who is creating the webpage to hard code what rows are to be moved and where, or end up creating multiple rules and/or page files in order to accommodate the change in screen size and be able to rearrange content in order to fit said screen size. As shown in FIG. 14, the user has selected the feature or icon 130 that that there be no columns left, thus moving the right column from next to the left column to under the third column

This method also allows for the potential for users to dictate in what order the content and containers on the page, with the user in the options having the ability to nominate the order. This can allow a user to potentially set up the way the content is shown on the page while minimizing the amount of time that is needed to load the page by not having to hide certain content that the user who is designing the canvas may choose to place in a different area of the page. An example of this would be a search bar that the user on a web page may choose to have at the top right of the corner, and believes that it works well within that area. However for a mobile phone view, the user, while wanting to keep the search bar on the page, would like it placed in a different area. By nominating the container where it is located, the user without having to implement any code, will be able to drag and drop the container when on a design view, thus preventing the user from having to create two search bars for one page.

The user also has an option to choose to see how the proposed website will look from the perspective of an end user. In the illustrative examples in the Figures, this option is located in the top left corner of the application 103 in which the user has the ability to view the page from outside of design view. As such, this will give the user the perspective to see how these changes look without the grid as well as allow the user to change the size of the screen in order to see how this content will look based on certain screen sizes i.e.; determining is a color palette works within the confines of the website that they are creating, the positioning of the content in which the user has created and/or how the page will look through certain changes and/or testing.

This method overall allows the user to create responsive intranet, extranet and internet web pages quickly and easily, without the user not needing to know how to code and/or need to take specialized education in order to create the web pages.

### CONCLUSION

This system and method will aid users in creating, sleek, seamless and responsive designs that will invariable lead to internet, extranet, or internet sites having higher adoption rates. It provides a user-friendly experience in:
1. Creating pages and choosing templates for both site design and screen design
2. Utilizing the tiles Workspace to drag and drop tiles
3. Choosing from a large selection of templates for different device sizes and styles.
4. Grouping tiles together, increasing efficiency, customization and responsiveness.
5. Configuring content containers for optimum customization.
6. Allowing users who are unfamiliar with coding and web design the tools needed to create responsive websites using a drag and drop interface.

What is claimed is:

1. A system comprising a processor and a computer-readable storage device, the device storing executable instructions that when processed by said processor causes said processor to implement the steps comprising:
creating or modifying a design canvas of a responsive intranet, internet or extranet page; and
adding content to the responsive intranet, internet or extranet page.

2. The system of claim 1 further including step of the intranet, internet or extranet page responding to the size of the screen in the device that the responsive intranet, internet or extranet page is being viewed.

3. The system of claim 1 wherein the layout of the responsive intranet, internet or extranet page is created by adding containers or rows.

4. The system of claim 2 wherein the containers or rows are added by a user dragging and dropping said containers or rows.

5. The system of claim 1 wherein the content includes one or more tiles.

6. The system of claim 1 wherein adding one or more tiles is by user interaction.

7. A system for creating or modifying an intranet, internet or extranet page that responds to the size of the screen of the device that said page is being viewed upon comprising:
a user interface;
a web effects controller component;
one or more web effect class libraries; and
a functional flow logic component.

8. A computer-implemented method comprising:
creating or modifying a design canvas of a responsive intranet, internet or extranet page; and
adding content to the responsive intranet, internet or extranet page.

9. A computer-implemented method of claim 8 wherein the adding content comprises:
selecting one or more tiles from a tile list of available tiles to add to the intranet, internet or extranet page; and
positioning the one or more tiles on said intranet, internet or extranet page.

10. The method of claim 8 further including step of the design space responding to the size of the screen in the device that the responsive intranet, internet or extranet page is being viewed.

11. The system of claim 8 wherein the layout of the responsive intranet, internet or extranet page is created by adding containers or rows.

12. The system of claim 11 wherein the containers or rows are added by a user dragging and dropping said containers or rows.

13. The system of claim 8 wherein the content includes one or more tiles.

14. The system of claim 8 wherein adding one or more tiles is by user interaction.
